(19) United States
(12) Patent Application Publication
(10) Pub. No.: US 2023/0027430 A1
(43) Pub. Date: Jan. 26, 2023

(54) ISOLATED OLEOSOME COMPOSITION AND PROCESS FOR PREPARING IT

(71) Applicant: CARGILL, INCORPORATED, Wayzata, MN (US)

(72) Inventor: Lucia CABAS-RODRIGUEZ, Antwerpen (BE)

(73) Assignee: CARGILL, INCORPORATED, Wayzata, MN (US)

(21) Appl. No.: 17/785,207

(22) PCT Filed: Nov. 9, 2020
(86) PCT No.: PCT/US2020/059615

§ 371 Date: Jun. 14, 2022

(30) Foreign Application Priority Data
Dec. 16, 2019 (EP) 19216522.3
Jan. 15, 2020 (EP) 20151963.4

(51) Int. Cl. C11B 1/04; A23L 5/10; A23D 9/007

(52) U.S. Cl. CPC C11B 1/04; A23D 9/007; A23L 5/10

(57) ABSTRACT

The invention relates to a process for preparing an isolated oleosome composition with improved taste and the process is comprising the steps of subjecting an oleosome source to a roasting step and obtaining a roasted oleosome source, and subsequently isolating oleosomes from the roasted oleosome source, and obtaining the isolated oleosome composition. The invention also relates to an isolated oleosome composition obtainable by the process. The invention further relates to food and feed products, pharmaceutical products, personal care products, nutritional compositions and industrial products comprising the isolated oleosome composition. Finally, the invention relates to the use of a roasted oleosome source to improve taste and/or flavor of an isolated oleosome composition.

### FIELD OF THE INVENTION

The invention relates to a process for preparing an isolated oleosome composition with improved taste and the process is comprising the steps of subjecting an oleosome source to a roasting step and obtaining a roasted oleosome source, and subsequently isolating oleosomes from the roasted oleosome source, and obtaining the isolated oleosome composition. The invention also relates to an isolated oleosome composition obtainable by the process. The invention further relates to food and feed products, pharmaceutical products, personal care products, nutritional compositions and industrial products comprising the isolated oleosome composition. Finally, the invention relates to the use of a roasted oleosome source to improve taste and/or flavor of an isolated oleosome composition.

### BACKGROUND OF THE INVENTION

Oleosomes, also known as “oil bodies”, “lipid bodies”, “lipid droplets” or “spherosomes”, are pre-emulsified droplets or vesicles of oil stored in plant seeds and used as energy source for plant growth and metabolism.

Oleosomes are typically extracted from cells by a process of grinding the seeds and subsequently washing, filtering and homogenising the ground seeds to form an aqueous suspension. Said suspension is centrifuged to separate the oleosomes.

Oleosomes are used typically for their excellent emulsification capacity. Oleosomes may also offer a natural source of oils that have not been subjected to severe refining processes.

However, oleosomes have a typical vegetable, green taste that remains even after further washing and/or purification steps. This taste is often perceived as unpleasant in food, feed, pharmaceutical or personal care applications.

There is a need for isolated oleosome compositions with an improved taste and a process for obtaining such oleosomes. The present invention addresses this need.

### SUMMARY OF THE INVENTION

The current invention relates to a process for preparing an isolated oleosome composition with improved taste and the process is comprising the steps of:
a) Subjecting an oleosome source to a roasting step and obtaining a roasted oleosome source, and
b) Isolating oleosomes from the roasted oleosome source, and obtaining the isolated oleosome composition.

The invention also relates to an isolated oleosome composition obtainable by the process.

The invention further relates to food and feed products, pharmaceutical products, personal care products, nutritional compositions and industrial products comprising the isolated oleosome composition.

Finally, the present invention relates to the use of a roasted oleosome source to improve taste and/or flavor of an isolated oleosome composition.

### DETAILED DESCRIPTION

The current invention relates to a process for preparing an isolated oleosome composition with improved taste and the process is comprising the steps of:
a) Subjecting an oleosome source to a roasting step and obtaining a roasted oleosome source, and
b) Isolating oleosomes from the roasted oleosome source, and obtaining the isolated oleosome composition.

“Isolated oleosomes” are pre-emulsified droplets or vesicles of oil that are present in cells and that have been obtained, taken, extracted and/or isolated from these cells.

An “oleosome source” is defined in the current invention as plant cells, fungal cells, yeast cells, bacterial cells or algae cells.

In one aspect of the invention the oleosome source are cells from pollens, spores, seeds or vegetative plant organs in which oleosomes or oleosomes-like organelles are present. Preferably, the sources of origin of the oleosomes used in accordance with the invention are members of the Brassicaceae, Amaranthaceae, Asparagaceae, Echium, Glycine, Astaraceae, Fabaceae, Malvaceae, Faboidae, Aracaceae, Euphorbiceae, Sinapsis, Lamiaceae, Cyperaceae, Anacardiaceae, Rosaceae, Betulaceae, Juglandaceae, Oleaceae, Lauraceae, Sapotaceae and/or Poaceae families. More preferably, an oleosome source are plant seed and most preferably plant seeds of plant species comprising: rapeseed ( Brassica spp.), soybean ( Glycine max), sunflower ( Helianthus annuits), oil palm ( Elaeis guineeis), cottonseed ( Gossypium spp.), groundnut ( Arachis hypogaea), coconut ( Cocus nucifera), castor ( Ricinus communis), safflower ( Carthamus tinctorius), mustard ( Brassica spp. and Sinapis alba), coriander ( Coriandrum sativum), squash ( Cucurbita maxima), linseed/flax ( Linum usitatissimum) (including brown (also called bronze) and yellow (also called gold) linseed), Brazil nut ( Bertholletia excelsa), hazelnut ( Corylus avellana), walnut ( Juglands major), jojoba ( Simmondsia chinensis), thale cress ( Arabidopsis thaliana), wheat and wheat germ ( Triticum spp.), maize and maize germ ( Zea mays), amaranth (family of Amaranthus), sesame ( Sesamum indicum), oat ( Avena sativa), camelina ( Camelina sativa), lupin ( Lupinus), peanut ( Arachis hypogaea), quinoa ( Chenopodium quinoa), chia ( Salvia hispanica), yucca, almond ( Prunus dulcis), cashew ( Anacardium occidentale), olive ( Olea), avocado ( Persea americana), shea ( Butyrospermum parkii), cocoa bean ( Theobroma cacao), argan ( Argania spinosa), rice, their corresponding mid or high oleic varieties and any variety with increased level of unsaturated fatty acids compared to the original seed variety. Varieties of these seeds may be obtained by natural selection or by genetic modification (GMO).

In a particular aspect of the invention, an oleosome source in step a) of the process may be a vegetable sources selected from the group consisting of rapeseed and rapeseed varieties with increased level of unsaturated fatty acids compared to the original rapeseed, soybean, sunflower and corresponding mid or high oleic varieties, cottonseed, coconut, brown linseed, yellow linseed, hazelnut, maize, sesame, almond, cashew, olive, avocado and shea. The isolated oleosome composition is originating from a vegetable source selected from the group consisting of rapeseed, soybean, sunflower, mid and high oleic sunflower, cottonseed, coconut, linseed, hazelnut, maize, sesame, almond, cashew, olive, avocado and shea. Further the oleosome source may be selected from the group consisting of rapeseed, sunflower, mid and high oleic sunflower, soybean, coconut, brown linseed, yellow linseed and hazelnut. Finally, the oleosome source may be selected from the group consisting of rapeseed, sunflower, high oleic sunflower, soybean, brown linseed and yellow linseed.

In one aspect of the invention, the oleosome source in step a) of the process is not an animal source.

In step a) of the process according to the invention the oleosome source is subjected to a roasting step and a roasted oleosome source is obtained.

Roasting is defined as a heat treatment at temperatures from 110° C. aiming at the generation of roast flavor compounds (providing improved taste), a brown color and/or a crunchy texture. More in particular, the roasting in the current process is aiming to reduce the off flavour and to obtain a bland taste. The isolated oleosome composition may suffer from a “green” off flavour and by roasting the oleosome source prior to isolating the oleosome composition, this greenish flavour is reduced and the isolated oleosome composition has a neutral taste.

The roasting in step a) of process according to the invention may be applied by means of hot air, including some special methods such as infrared and microwave processes, and by means of oil roasting, i.e. by immersing the oleosome source into hot oil.

In one aspect of the invention the roasting in step a) is applied by means of hot air.

Different types of roasting equipment wherein products are roasted by means of hot air may be used such as, but not limited to batch roasters, in the form of traditional ball and drum roasters or in the form of semi- fluidized systems, or continuous roasters in the form of single belt convection roasters, vertical continuous roasters or continuous drum roasters.

In one aspect of the invention, the roasting in step a) of the process may involve a preheating step at an intermediate temperature and under moist conditions, followed by a higher temperature dry roasting step.

In one aspect of the invention, the roasting step a) of the process is applied at a temperature in a range of from 110 to 160° C., from 115 to 150° C., from 120° C. to 145° C., from 125 to 140° C., or from 130 to 135° C.

In another aspect of the invention, the roasting step a) is applied during a period of time in a range of from 5 to 60 minutes, from 10 to 50 minutes, from 15 to 45 minutes, from 15 to 40 minutes, from 20 to 35 minutes, or from 25 to 30 minutes.

In yet another aspect of the invention the roasting step a) of the process is applied at a relative humidity in a range of from 10 to 30%, 12 to 25%, or from 15 to 20%. This level of humidity can be achieved by injection of steam while roasting.

Further, in a another aspect of the invention, the roasting step a) of the invention is applied at a temperature of from 110 to 145° C. for a period of from 15 to 60 minutes, from 115 to 135° C. for a period of from 20 to 45 minutes, from 120° C. to 130° C. for a period of from 30 to 50 minutes. Alternatively, the roasting step is applied at a temperature of from 150 to 160° C. for a period of from 5 to 35 minutes, from 7 to 25 minutes, or from 10 to 20 minutes.

The roasted oleosome source obtained in step a) is characterized in that it has a content of
pyrazine in a range of from 0.15 to 1.20 ppm, or
2,5 dimethylpyrazine in a range of from 0.25 to 1.00 ppm, or
2-ethyl-3-methylpyrazine in a range of from 0.10 to 0.60 ppm, or
2-ethy-3,5-dimethylpyrazine in a range of from 0.05 to 0.30 ppm, or any combination of two or more thereof.

The roasted oleosome source obtained in step a) is characterized in that it has a content of pyrazine in a range of from 0.15 to 1.20 ppm, from 0.20 to 1.10 ppm, from 0.25 to 1.00 ppm, or from 0.30 to 0.90 ppm.

Further, the roasted oleosome source obtained in step a) is characterized in that it has a content of 2,5 dimethylpyrazine in a range of from 0.25 to 1.00 ppm, from 0.30 to 0.90 ppm, from 0.35 to 0.80 ppm, or from 0.40 to 0.70 ppm.

Additionally, the roasted oleosome source obtained in step a) is characterized in that it has a content of 2-ethyl-3-methylpyrazine in a range of from 0.10 to 0.60 ppm, from 0.15 to 0.55 ppm, or from 0.20 to 0.50 ppm, or from 0.25 to 0.45 ppm.

Finally, the roasted oleosome source obtained in step a) is characterized in that it has a content of 2-ethy-3,5-dimethylpyrazine in a range of from 0.05 to 0.30 ppm, 0.08 to 0.27 ppm, from 0.10 to 0.25 ppm, from 0.13 to 0.20 ppm.

Without being bound by theory, pyrazine, 2,5 dimethylpyrazine, 2-ethyl-3-methylpyrazine and/or 2-ethy-3,5-dimethylpyrazine are, amongst others, typical volatile compounds formed during roasting. The presence of at least one of these components may therefore be a suitable indication of the level of roasting. These volatile compounds further contribute to the taste and aroma of roasted oleosome source. These volatile compounds can mask the off flavor.

The content of volatile compounds present in the roasted oleosome source, and more specifically the content of pyrazine, 2,5 dimethylpyrazine, 2-Ethyl-3-methylpyrazine and/or 2-ethy-3,5-dimethylpyrazine may be analyzed by methods well known in the art.

Typically, the volatiles compounds are extracted from the ground roasted oleosome source by means of head-space extraction. The extracted volatile compounds are subsequently analyzed by means of GC-MS. The identification of the volatile compounds may be done by comparison of the mass spectra with reference standards. The relative concentration of each compound is calculated based on the area of the internal standard.

In step b) of the process according to the invention oleosomes are isolated from the roasted oleosome source and an isolated oleosome composition is obtained.

The methods for isolating oleosomes are well known in the art.

Typically, seeds are processed by mechanical pressing, grinding or crushing. A liquid phase, e.g. water, may also be added prior to grinding of the seeds, which is known as wet milling.

Following grinding, a slurry is obtained and filtrated. The filtrate may be subsequently separated by applying centrifugal acceleration which separates the filtrate into two liquid phases, a watery phase and an oily oleosome containing phase.

Alternatively, the slurry obtained after grinding may be submitted to a liquid-solid separation (two-phase separation) or a liquid-solid-liquid separation (three-phase separation) using a centrifugal decanter. Both separation techniques follow the same operating principle.

The isolated oleosome composition obtained from step b) of the process has a dry matter content in a range of from 30 to 80 wt%, from 40 to 70 wt%, or from 50 to 60 wt%.

Based on total dry matter it has:
a protein content of from 1.0 to 6.0%, from 1.5 to 5.0%, from 2.0 to 4.0%, and
an oil content of from 94 to 99%, from 95 to 98.5%, or from 96 to 98%, of which at least 60%, at least 70%, at least 80%, or at least 90% is present as oleosomes.

Surprisingly it is found that by applying the roasting step a) of the process, the isolated oleosomes of the roasted oleosome source remain intact or at least almost intact. As a result, a recovery level of the isolated oleosome composition obtained from step b) of the process is almost identical to the recovery level of oleosomes isolated from an oleosome source that has not been subjected to a roasting step. The recovery level of the isolated oleosome composition is at least 60%, at least 70%, at least 80%, at least 85%, at least 90%, even at least 95% of the recovery level of oleosomes isolated from an oleosome source that has not been subjected to a roasting step.

Additionally, it is found that the process according to the invention results in an isolated oleosome composition with an improved taste and/or flavour compared to the taste and/or flavour of oleosomes that are isolated from an oleosome source that has not been subjected to a roasting step.

In a sensorial evaluation by an experienced taste panel, the taste of oleosomes isolated from an oleosome source that has not been subjected to a roasting step was described as an unpleasant vegetable, greenish and/or slightly bitter off taste. By subjecting the oleosome source to the roasting step according to the invention, the off flavor is reduced or is even completely removed from the isolated oleosome composition. However, the isolated oleosome composition has substantially no or minor typical flavors associated with roasting. The isolated oleosome composition has a bland flavour and taste.

Furthermore, it was found that the process according to the invention results in a stable isolated oleosome composition. A way to measure the stability of the isolated oleosome composition is the measurement of the average globule diameter. By applying the process according to the invention, the average globule diameter of the oleosomes in the isolated oleosome composition will not increase by more than 20%, more than 15%, or even more than 10%. This average globule diameter is also stable over time. The stability of the isolated oleosome composition may be observed by the D10, D50 and D90 value of the oleosomes in the isolated oleosome composition that remain practically constant over time. Typically, D10, D50 and D90 will not change with more than 10%, more than 5% during storage over a period of 3 days.

In the current invention, the average globule diameter of the oleosomes is expressed as the D50-value (D50). The D50-value of oleosomes is the diameter below which 50% of the volume of oleosome particles lies, and it is expressed in micron. The oleosomes are measured in diluted form of approximately 0.2% oleosomes in buffer solution of 10 mM sodium phosphate, pH 7.4, and 1% sodium dodecyl sulphate (SDS). SDS is generally used to measure real particle sizes by preventing flocculation conditions. For the purpose of the invention, the oleosomes are considered to be spherical and in case of non-spherical oleosomes, the diameter is considered as being the largest dimension that can be measured between two opposite points on the surface thereof. D50 may be determined using a Mastersizer 2000 (or 3000) from Malvern. D90, and D10-value are measured in a similar defined manner as D50-value. D90-value of oleosomes is the diameter below which 90% of the volume of oleosome particles lies. D10-value of oleosomes is the diameter below which 10% of the volume of oleosome particles lies. The particle size distribution (PD) of the oleosomes is defined as: (D90-D10)/D50.

In one aspect of the invention, the isolated oleosome composition obtained from step b) of the process may be further subjected to a washing step. The isolated oleosome composition may for example be washed by re-suspending them in a floatation solution of lower density (e.g. water, aqueous buffer with neutral to alkaline pH up to 9.5) and by subsequently separating them again from the aqueous phases by means of centrifugation. The washing procedure may be repeated several times, from one up to three times.

In another aspect of the invention the isolated oleosome composition obtained in step b) of the process may be further subjected to a heat treatment step. The heat treatment may be a pasteurization treatment or an ultra-high-temperature (UHT) treatment. Pasteurization treatment involves heating the oleosomes at a temperature of 65° C. to 70° C. for 30 minutes in batch or 80° C. to 85° C. for 15 to 25 seconds in a continuous-flow process (High temperature short time Pasteurization (HTST)). UHT treatment involves heating of the isolated oleosome composition at a temperature of 135° C. to 150° C. in a continuous-flow process and holding at that temperature for one or more seconds, up to 5 seconds, before cooling rapidly to room temperature.

The heat treatment step of the isolated oleosomes composition obtained in step b) of the process may be applied to further avoid microbial contamination of the oleosomes. Therefore, the oleosomes composition may be preserved for a longer period without addition of any preservatives. It has been found that the oleosomes in the isolated oleosomes composition maintain their average globule diameter when being subjected to such a heat treatment step.

In yet another aspect of the invention the isolated oleosomes composition may be further subjected to a dehydration step. Dehydration steps well known to the person skilled in the art are amongst others spray drying, fluid bed drying, freeze drying or vacuum drying.

The thus obtained oleosomes are in a more concentrated liquid form or in a powder form. In one aspect of the invention, the dehydration step is a spray-drying step.

Spray-drying may allow for a convenient packaging of the isolated oleosomes composition and storage at room temperature. It also facilitates the dosing of isolated oleosome composition as ingredient in the preparation of further products.

In one aspect of the invention, the process for preparing an isolated oleosome composition with improved taste is comprising the steps of:
a) Subjecting an oleosome source to a roasting step at a temperature in a range of from 110° C. to 160° C. during a period in a range of from 5 to 60 minutes, and obtaining a roasted oleosome source, and
b) Isolating oleosomes from the roasted oleosome source, and obtaining the isolated oleosome composition,
c) Optionally washing the isolated oleosome composition,
d) Heat treating the isolated oleosome composition from step b or step c), and
e) Optionally dehydrating the heat treated isolated oleosome composition from step c).

In another aspect of the invention, the process for preparing an isolated oleosome composition with improved taste is comprising the steps of:
a) Subjecting an oleosome source to a roasting step at a temperature in a range of from 110° C. to 145° C. during a period in a range of from 15 to 60 minutes, and obtaining a roasted oleosome source, and
b) Isolating oleosomes from the roasted oleosome source, and obtaining the isolated oleosome composition,
c) Washing the isolated oleosome composition,
d) Heat treating the isolated oleosome composition from step c), and
e) Optionally dehydrating the heat treated isolated oleosome composition from step c), and wherein the roasted oleosome source in step a) is characterized in that it has a content of:
   Pyrazine in a range of from 0.15 to 1.20 ppm, or
   2,5 dimethylpyrazine in a range of from 0.25 to 1.00 ppm, or
   2-ethyl-3-methylpyrazine in a range of from 0.10 to 0.60 ppm, or
   2-ethy-3,5-dimethylpyrazine in a range of from 0.05 to 0.30 ppm, or any combination of two or more thereof.

In yet another aspect of the invention, the process for preparing an isolated oleosome composition with improved taste is comprising the steps of:
a) Subjecting an oleosome source to a roasting step at a temperature in a range of from 110° C. to 145° C. during a period in a range of from 15 to 60 minutes, and obtaining a roasted oleosome source at a relative humidity of 10 to 30%, and
b) Isolating oleosomes from the roasted oleosome source, and obtaining the isolated oleosome composition, and
c) Washing the isolated oleosome composition,
d) Heat treating the isolated oleosome composition from step c) by means of a UHT treatment, and
e) Optionally spray-drying the heat treated isolated oleosome composition from step c), and wherein the roasted oleosome source in step a) is characterized in that it has a content of:
   pyrazine in a range of from 0.15 to 1.20 ppm, or
   2,5 dimethylpyrazine in a range of from 0.25 to 1.00 ppm, or
   2-ethyl-3-methylpyrazine in a range of from 0.10 to 0.60 ppm, or
   2-ethy-3,5-dimethylpyrazine in a range of from 0.05 to 0.30 ppm, or any combination of two or more thereof.

The invention further relates to an isolated oleosome composition obtainable by the claimed process.

In one aspect of the invention the isolated oleosomes composition is obtainable by the claimed process wherein the roasted oleosome source is characterized in that it has a content of:
pyrazine in a range of from 0.15 to 1.20 ppm, or
2,5 dimethylpyrazine in a range of from 0.25 to 1.00 ppm, or
2-ethyl-3-methylpyrazine in a range of from 0.10 to 0.60 ppm, or
2-ethy-3,5-dimethylpyrazine in a range of from 0.05 to 0.30 ppm, or any combination of two or more thereof.

It is found that the isolated oleosome composition obtainable by the process according to the invention results in an improved taste and/or flavour compared to the taste and/or flavour of oleosomes that are isolated from an oleosome source that has not been subjected to a roasting step.

In a sensorial evaluation by an experienced taste panel, the taste of oleosomes isolated from an oleosome source that has not been subjected to a roasting step was described as an unpleasant vegetable, greenish and/or slightly bitter off taste. By subjecting the oleosome source to the roasting step according to the invention, the off taste may be reduced or even removed from the isolated oleosome composition. However, the isolated oleosome composition has substantially no or minor typical flavors associated with roasting.

Additionally, the average globule diameter of the oleosomes in the isolated oleosome composition obtainable by the process according to the invention will not increase by more than 20%, more than 15%, or even more than 10%. This average globule diameter is also stable over time. The stability of the isolated oleosome composition may be observed by the D10, D50 and D90 value of the oleosomes in the isolated oleosome composition that remain practically constant over time. Typically, D10, D50 and D90 will not change with more than 10%, more than 5% during storage over a period of 3 days.

The invention further relates to food and feed products, pharmaceutical products, personal care products, nutritional compositions and industrial products comprising the isolated oleosomes composition.

Examples of such food and feed products include but not limited to drinks such as coffee, black tea, powdered green tea, cocoa, juice etc.; milk component-containing drinks, such as raw milk, processed milk, lactic acid beverages, etc.; a variety of drinks including nutrition-enriched drinks, such as calcium-fortified drinks and the like and dietary fibercontaining drinks, etc.; dairy products, such as butter, cheese, vegan cheese, yoghurt, coffee whitener, whipping cream, custard cream, custard pudding, etc.; iced products such as ice cream, soft cream, lacto-ice, ice milk, sherbet, frozen yogurt, etc.; processed fat food products, such as mayonnaise, margarine, spread, shortening, etc.; soups; stews; seasonings such as sauce, dressings, etc.; a variety of paste condiments represented by kneaded mustard; a variety of fillings typified by jam and flour paste; a variety or gel or paste-like food products including red bean-jam, jelly, and foods for swallowing impaired people; food products containing cereals as the main component, such as bread, noodles, pasta, pizza pie, corn flake, etc.; Japanese, US and European cakes, candy, cookie, biscuit, hot cake, chocolate, rice cake, etc.; kneaded marine products represented by a boiled fish cake, a fish cake, etc.; live-stock products represented by ham, sausage, hamburger steak, etc.; daily dishes such as cream croquette, paste for Chinese foods, gratin, dumpling, etc.; foods of delicate flavor, such as salted fish guts, a vegetable pickled in sake lee, etc.; liquid diets such as tube feeding liquid food, etc.; supplements; and pet foods.

Pharmaceutical products according to the invention may be formulated to include therapeutic agents, diagnostic agents and delivery agents. As a therapeutic or diagnostic agent, the product will additionally contain an active ingredient. The active ingredient can be anything that one wishes to deliver to a host. The active ingredient may be a protein or peptide that has therapeutic or diagnostic value. Such peptides include antigens (for vaccine formulations), antibodies, cytokines, blood clotting factors and growth hormones. An example of pharmaceutical product is a parenteral emulsion containing the oleosomes composition and a drug.

Personal care products according to the invention include soaps, cosmetics, skin creams, facial creams, toothpaste, lipstick, perfumes, make-up, foundation, blusher, mascara, eyeshadow, sunscreen lotions, hair conditioner, and hair coloring.

Industrial products according to the invention include paints, coatings, lubricants, films, gels, drilling fluids, paper sizing, latex, building and road construction material, inks, dyes, waxes, polishes and agrochemical formulations.

Nutritional compositions according to the invention may be compositions that are developed to cover the nutritional needs, either as a supplement, or as a complete nutrition.

The people that are targeted for the nutritional composition according to the invention relate to specific groups of people, such as, but not limited to, preterm infants, infants, toddlers, invalids, elderly people, athletes or humans having nutritional deficiencies and/or having a deficient immune system. They may be designed for people suffering a more specific disease states such as cancer, chronic obstructive pulmonary disease, and later-stage kidney disease and others. Amongst others, nutritional compositions may be helpful for people who struggle with a loss of appetite, have difficulty chewing, have trouble preparing balanced meals, and/or are recovering from surgery or an illness. In the event that the nutritional composition is meant for a complete nutrition, it can provide a healthy balance of protein, carbohydrate, and/or fat.

These nutritional compositions can be in the form of liquid, as a ready-to-drink formula or used in feeding tubes. It can also be in the form of a formula base i.e. a powder or a concentrated liquid, to be dissolved in water or in another fluid for the preparation of a ready-to-drink nutritional composition. The nutritional composition may also be in the form of a pudding or a jelly, or in form a cookie or a snack bar, or in any other form.

In one aspect of the invention the nutritional composition is comprising the isolated oleosomes composition in an amount of from 1 to 70 weight% on dry matter of the nutritional composition and at least one nutritional ingredient other than oleosomes. The nutritional composition is comprising at least one nutritional ingredient other than isolated oleosomes and the isolated oleosome composition in an amount of from 5 to 65 weight%, from 10 to 60 weight%, from 15 to 55 weight%, from 20 to 50 weight%, or from 25 to 45 weight% on dry matter of the nutritional composition. The at least one nutritional ingredient other than isolated oleosomes may be, but is not limited to proteins, carbohydrates, fats, vitamins, minerals, trace elements, essential amino acids, essential fatty acids, and mixtures of two or more thereof.

In another aspect of the invention the nutritional composition further comprises at least one non-nutritional ingredients.

Non-nutritional ingredients are defined as ingredients that do not substantially add to the caloric intake and/or do not substantially provide micronutrients. Examples of non-nutritional ingredients are flavors, colorants, emulsifiers, acid regulators such as citric acid or lactic acid, preservatives, and the like. The non-nutritional ingredients may be from a natural or synthetic origin.

The taste food and feed products, pharmaceutical products, personal care products and in particular nutritional compositions comprising the isolated oleosomes composition is perceived as good to excellent. An experienced taste panel may report the absence of an unpleasant vegetable, greenish off flavor.

Finally, the current invention relates to the use of a roasted oleosome source to improve taste and/or flavor of isolated oleosome composition.

In one aspect, the use of the current invention relates to a roasted oleosome source that is obtained by a roasting step at a temperature in a range of from 110 to 160° C., from 115 to 150° C., from 120° C. to 145° C., from 125 to 140° C., or from 130 to 135° C.

In another aspect, the use of the current invention relates to a roasted oleosome source that is obtained by a roasting step that is applied during a period of time in a range of from 5 to 60 minutes, from 10 to 50 minutes, from 15 to 45 minutes, from 15 to 40 minutes, from 20 to 35 minutes, or from 25 to 30 minutes.

In a further aspect, the use of the current invention relates to a roasted oleosome source that is obtained by a roasting step that is applied at a relative humidity in a range of from 10 to 30%, 12 to 25%, or from 15 to 20%. This level of humidity can be achieved by injection of steam while roasting.

In yet one more aspect, the use of the current invention relates to a roasted oleosome source that is obtained by a roasting step that is applied at a temperature of from 110 to 145° C. for a period of from 15 to 60 minutes, from 115 to 135° C. for a period of from 20 to 45 minutes, from 120° C. to 130° C. for a period of from 30 to 50 minutes.

Alternatively, the use of the current invention relates to a roasted oleosome source that is obtained by a roasting step that is applied at a temperature of from 150 to 160° C. for a period of from 5 to 35 minutes, from 7 to 25 minutes, or from 10 to 20 minutes.

In yet another aspect, the use of the current invention relates to a roasted oleosome source characterized in that it has a content of
pyrazine in a range of from 0.15 to 1.20 ppm, or
2,5 dimethylpyrazine in a range of from 0.25 to 1.00 ppm, or
2-ethyl-3-methylpyrazine in a range of from 0.10 to 0.60 ppm, or
2-ethy-3,5-dimethylpyrazine in a range of from 0.05 to 0.30 ppm, or any combination of two or more thereof.

### EXAMPLES

### 1. Roasting of the Oleosome Source

Dehulled sunflower seeds were roasted using coffee roaster (Gene Café Model CBR 101. Roasting conditions (temperature and time) are described in table 1.

Table 1

Roasting conditions

| | | |
|---|---|---|
| | Roasting temperature | Roasting time |
| Example 1 | 135° C. | 30 min |
| Example 2 | 135° C. | 45 min |
| Example 3 | 145° C. | 30 min |
| Comparative example 1 | unroasted | - |
| Comparative example 2 | 165° C. | 30 min |

### 2. Isolation of the Olesomes

100 g of dehulled raw sunflower seeds or dehulled sunflower seeds that were roasted according to the roasting conditions in table 1, were soaked during 2 h in de-ionized water (ratio 1:3 seeds:water) at 4° C. The soaking water was discarded, and the soaked seeds were washed with de-ionized water (ratio 1:2 seed: demi-water). The washed seeds were grinded together with de-ionized water in a weight ratio of 1:10 of seeds/water. A Thermomix® TM5 (Vorwerk) was used for grinding at a speed of 10700 rpm for 90 sec. The obtained slurry of seeds and water was subsequently filtered over a nylon filter with a pore diameter of 80 µm.

The pH of the obtained filtrate was adjusted to 7.5 with sodium hydroxide solution.

This filtrate was centrifuged for 30 minutes at 5000 rpm (4950 × g, Thermo Scientific Sorvall Legend) to create a top layer. This is the first centrifugation step. The centrifugation process separates this liquid phase further into two liquid phases: a hydrophilic phase (supernatant) which was a watery solution of proteins, carbohydrates and soluble fibers and a hydrophobic phase (creamy top layer) which contained the desired oleosomes. In addition to the two liquid phases, a solid pellet that contained cell debris and insoluble proteins was obtained.

### 3. Results

The recovery level (expressed in % of dry substance) of the creamy top layer (i.e. the isolated oleosome composition) was measured and compared to the yield obtained from raw, unroasted sunflower seeds. Results are shown in table 2.

Table 2

Yield of isolated oleosome composition

| | Recovery level (% dry substance) | Globule size ― D50 |
|---|---|---|
| Example 1 | 45.0% | |
| Example 2 | 40.1% | 1.70 |
| Example 3 | 37.8% | 1.78 |
| Comparative example 1 | 47.5% | 1.53 |
| Comparative example 2 | 23.3% | 28.3 |

1. A process for preparing an isolated oleosome composition with improved taste and the process is comprising the steps of:
a) Subjecting an oleosome source to a roasting step and obtaining a roasted oleosome source, and
b) Isolating oleosomes from the roasted oleosome source, and obtaining an isolated oleosome composition.

2. The process according to claim 1, wherein the oleosome source is selected from the group consisting of rapeseed, soybean, sunflower, mid and high oleic sunflower, cottonseed, coconut, linseed, hazelnut, maize, sesame, almond, cashew, olive, avocado and shea.

3. The process according to claim 1 to, wherein the roasting step in step a) is applied at a temperature in a range of from 110 to 160° C.

4. The process according to claim 1 , wherein the roasting step in step a) is applied during a period of time in a range of from 5 to 60 minutes.

5. The process according to claim 1 , wherein the roasting step in step a) is applied at a relative humidity in a range of from 10 to 30%.

6. The process according to claim 1 , wherein the roasted oleosome source obtained in step a) is characterized in that it has a content of:
pyrazine in a range of from 0.15 to 1.20 ppm, or
2,5 dimethylpyrazine in a range of from 0.25 to 1.00 ppm, or
2-ethyl-3-methylpyrazine in a range of from 0.10 to 0.60 ppm, or
2-ethy-3,5-dimethylpyrazine in a range of from 0.05 to 0.30 ppm, or any combination of two or more thereof.

7. An isolated oleosome composition obtainable by the process according to claim 1 .

8. The isolated oleosome composition according to claim 7, wherein the roasted oleosome source obtained in step a) of the process is characterized in that it has a content of:
pyrazine in a range of from 0.15 to 1.20 ppm, or
2,5 dimethylpyrazine in a range of from 0.25 to 1.00 ppm, or
2-ethyl-3-methylpyrazine in a range of from 0.10 to 0.60 ppm, or
2-ethy-3,5-dimethylpyrazine in a range of from 0.05 to 0.30 ppm, or any combination of two or more thereof.

9. Food and feed products, pharmaceutical products, personal care products, nutritional compositions and industrial products comprising the isolated oleosomes composition according to claim 7.

10. The nutritional composition according to claim 9 and the nutritional composition is comprising the isolated oleosomes composition in an amount of from 1 to 70 wt% on total weight of the nutritional composition and at least one nutritional ingredient other than isolated oleosomes.

11-15. (canceled)

16. The process of claim 1, wherein the process improves taste and/or flavor of the isolated oleosome composition compared to the taste and/or flavor of oleosomes that are isolated from an oleosome source that has not been subjected to a roasting step.

17. A method of using a roasted oleosome source to improve taste and/or flavor of an isolated oleosome composition, the method comprising:
roasting an oleosome source at a temperature in a range of from 110 to 160° C. to obtain a roasted oleosome source.

18. The method of claim 17, wherein the roasting is applied during a period of time in a range of from 5 to 60 minutes.

19. The method of claim 17, wherein the roasting is applied at a relative humidity in a range of from 10 to 30%.

20. The method of claim 17, wherein the roasted oleosome source is characterized in that it has a content of:
pyrazine in a range of from 0.15 to 1.20 ppm, or
2,5 dimethylpyrazine in a range of from 0.25 to 1.00 ppm, or
2-ethtl-2-methylpyrazine in a range of from 0.10 to 0.60 ppm, or
2-ethyl-3,5-dimethylpyrazine in a range of from 0.05 to 0.30 ppm, or any combination of two or more thereof.
